(19) United States
(12) Patent Application Publication
(10) Pub. No.: US 2025/0334140 A1
(43) Pub. Date: Oct. 30, 2025

(54) TELESCOPIC PIPE ASSEMBLY THAT CAN BE QUICKLY LOCKED

(71) Applicant: Guangdong Jinjie Technology Co., Ltd, Zhongshan (CN)

(72) Inventors: HONGBIN ZHANG, Zhongshan (CN); JINHUA LU, Zhongshan (CN)

(21) Appl. No.: 18/799,352

(22) Filed: Aug. 9, 2024

Related U.S. Application Data
(63) Continuation of application No. PCT/CN2024/106358, filed on Jul. 19, 2024.

(30) Foreign Application Priority Data
Apr. 30, 2024 (CN) 202420950082.5

(51) Int. Cl. F16B 7/14

(52) U.S. Cl. CPC F16B 7/1409; F16B 7/1454

(57) ABSTRACT

A telescopic pipe assembly that can be quickly locked is provided, which includes a first pipe fitting, a second pipe fitting, and a third pipe fitting that are sequentially connected and can move relative to each other in an axial direction. The second pipe fitting is provided with a main locking mechanism that limits a relative movement between the second pipe fitting and the first pipe fitting, and a secondary locking mechanism that limits a relative movement between the second pipe fitting and the third pipe fitting. The main locking mechanism and the secondary locking mechanism are respectively connected to an interlocking mechanism. When the main locking mechanism limits the relative movement between the second pipe fitting and first pipe fitting, the interlocking mechanism causes the secondary locking mechanism to limit the relative movement between the second pipe fitting and the third pipe fitting.

### CROSS-REFERENCE TO RELATED APPLICATIONS

This application is a continuation of International Application No. PCT/CN2024/106358, filed on Jul. 19, 2024, which claims priority to Chinese Patent Application No. 202420950082.5, filed on Apr. 30, 2024, both of which are hereby incorporated by reference in their entireties.

### TECHNICAL FIELD

The present disclosure relates to the field of photographic equipment technologies, and in particular, to a telescopic pipe assembly that can be quickly locked.

### BACKGROUND

The existing telescopic pipe assembly consists of multiple pipe fittings that are interlocked with each other. Due to the relative movement of several pipe fittings in the axial direction and the locking structure on adjacent pipe fittings, the length of the telescopic pipe assembly can be adjusted, rendering it flexible and convenient to use. The locking structure composed of known pipe fittings can only independently control the locking and unlocking of adjacent pipe bodies, so that the locking and unlocking of multiple pipe bodies require repeated operations, which is cumbersome.

### SUMMARY

A purpose of the present application is to provide a telescopic pipe assembly that can be quickly locked to solve the problem that the locking structure of the existing telescopic pipe assembly can only control the locking and unlocking of adjacent pipe fittings separately, and the locking and unlocking of multiple pipe fittings require repeated operations, which is cumbersome to operate.

The present application is implemented through the following technical solution.

A telescopic pipe assembly that can be quickly locked, including a first pipe fitting, a second pipe fitting, and a third pipe fitting that are sequentially connected and are capable of moving relative to each other in an axial direction; where the second pipe fitting is provided with a main locking mechanism that limits a relative movement between the second pipe fitting and first pipe fitting, and a secondary locking mechanism that limits a relative movement between the second pipe fitting and the third pipe fitting; the main locking mechanism and the secondary locking mechanism are respectively connected to an interlocking mechanism, the interlocking mechanism causes the secondary locking mechanism to limit the relative movement between the second pipe fitting and the third pipe fitting when the main locking mechanism limits the relative movement between the second pipe fitting and the first pipe fitting.

In an embodiment of the present disclosure, the second pipe fitting includes a main sliding seat sleeved on the first pipe fitting; the main locking mechanism includes a toggle buckle rotatably connected to the main sliding seat, a main pressing block and a main locking block accommodated in the main sliding seat; the main pressing block is matched with the main locking block; the toggle buckle drives the main pressing block to move forward and backward when rotates relative to the main sliding seat; forward and backward movements of the main pressing block drive the main locking block to move left and right so as to abut against or release the first pipe fitting.

In an embodiment of the present disclosure, the second pipe fitting includes a secondary sliding seat sleeved on the third pipe fitting; the secondary locking mechanism includes a secondary pressing block and a secondary locking block accommodated in the secondary sliding seat; the secondary locking block is matched with the secondary pressing block; when the main locking mechanism locks or releases the first pipe fitting, the interlocking mechanism causes the secondary pressing block to move up and down; up and down movements of the secondary pressing block drive the secondary locking block to abut against or release the third pipe fitting.

In an embodiment of the present disclosure, the interlocking mechanism includes a tension rope and a stop column, one end of the tension rope is connected to the main sliding seat and the other end of the tension rope is connected to the secondary pressing block; the stop column passes through the tension rope and cooperates with the toggle buckle to cause the secondary pressing block to move up and down so as to push the secondary locking block to abut against or release the third pipe fitting; the toggle buckle releases the stop column and causes the secondary pressing block to move upward when the main locking block is driven to move and abut against the first pipe fitting by the toggle buckle; the secondary locking block is pushed to abut against the third pipe fitting when the secondary pressing block moves upward; the toggle buckle abuts against the stop column and causes the secondary pressing block to move down when the main locking block is driven to move and release the first pipe fitting by the toggle buckle; the secondary locking block is pushed to release the third pipe fitting when the secondary pressing block moves down.

In an embodiment of the present disclosure, the secondary sliding seat is provided with an elastic member below the secondary pressing block, an elastic compression of the elastic member causes the secondary pressing block to move upward.

In an embodiment of the present disclosure, the secondary locking block is rotatably connected to the secondary sliding seat and at least partially wounds around an outside of the third pipe fitting, and the secondary locking block rotates toward the third pipe fitting and abuts against the third pipe fitting when the secondary pressing block moves upward.

In an embodiment of the present disclosure, the first pipe fitting includes two pipe bodies at left and right sides of the first pipe fitting; there are two main locking blocks; the two main locking blocks are respectively provided at left and right sides of the main pressing block and respectively abut against or release the two pipe bodies when the main pressing block moves forward and backward.

In an embodiment of the present disclosure, the main locking block includes a surrounding part that is provided around an outside the first pipe fitting.

In an embodiment of the present disclosure, one side of the main pressing block opposite to the toggle buckle is provided with an avoidance groove, and one side of the toggle buckle opposite to the main pressing block is provided with an avoidance strip; when the toggle buckle rotates relative to the main sliding seat, the avoidance strip is caused to move into or out of the avoidance groove; the toggle buckle abuts against the main pressing block so as to cause the main pressing block to move backwards when the avoidance strip is moved away from the avoidance groove; the main pressing block drives the main locking block to move and abut against the first pipe fitting when the main pressing block moves backwards; the toggle buckle releases the main pressing block so as to cause the main pressing block to move forward when the avoidance strip is moved into the avoidance groove; the main locking block is driven to move and release the first pipe fitting when the main pressing block moves forward.

The advantage of this technical solution is that by configuring the interlocking mechanism on the main locking mechanism that limits the relative movement between the first pipe fitting and the second pipe fitting, and the secondary locking mechanism that limits the relative movement between the second pipe fitting and the third pipe fitting, the main locking mechanism limits the relative movement between the first pipe fitting and the second pipe fitting, and the secondary locking mechanism limits the relative movement between the second pipe fitting and the third pipe fitting, thereby achieving synchronous locking and unlocking of multiple pipe fittings, simplifying the operation and facilitating the use.

### BRIEF DESCRIPTION OF DRAWINGS

FIG. 1 is a perspective view (in an elongated state) of a telescopic pipe assembly that can be quickly locked disclosed in an embodiment.

FIG. 2 is a perspective view (in a shortened state) of the telescopic pipe assembly disclosed in an embodiment.

FIG. 3 is a front view of the telescopic pipe assembly disclosed in an embodiment.

FIG. 4 is an enlarged partial view of along A-A in FIG. 3.

FIG. 5 is an enlarged partial view of C in FIG. 4.

FIG. 6 is an enlarged partial view along B-B in FIG. 3.

FIG. 7 is an enlarged partial view of D in FIG. 6.

FIG. 8 is an enlarged partial view of E in FIG. 6.

FIG. 9 is a perspective view of the telescopic pipe assembly disclosed in an embodiment (a secondary sliding seat being hidden).

FIG. 10 is an enlarged partial view of F in FIG. 9.

FIG. 11 is a perspective view of the telescopic pipe assembly disclosed in an embodiment (a main sliding seat being hidden).

FIG. 12 is an enlarged partial view of G in FIG. 11.

FIG. 13 is an exploded view of the telescopic pipe assembly disclosed in an embodiment.

### DESCRIPTION OF EMBODIMENTS

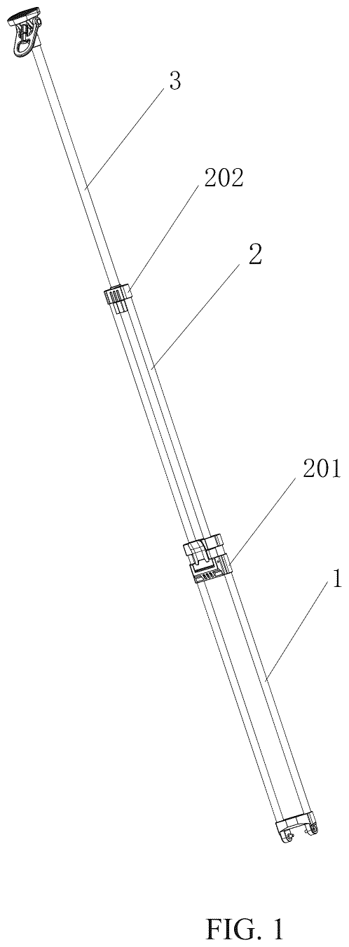

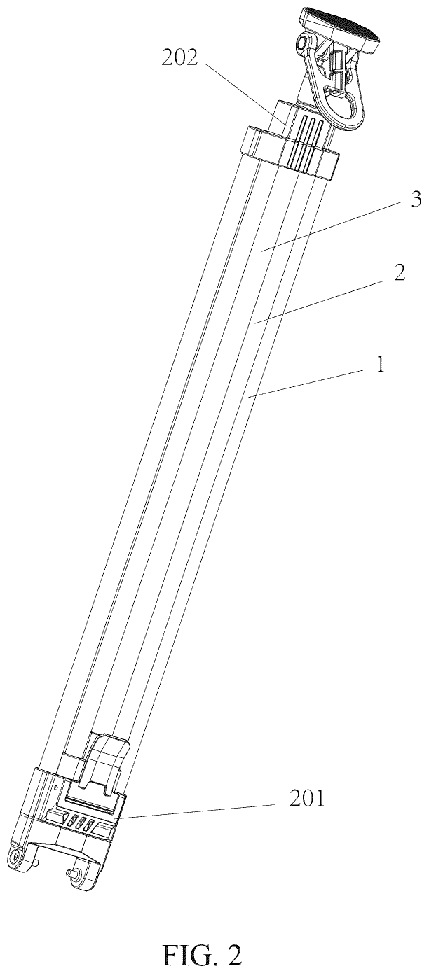

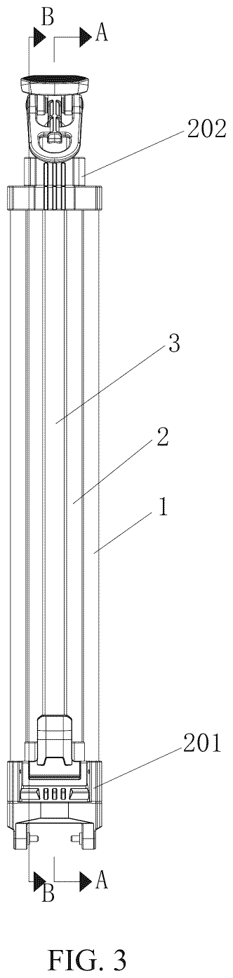

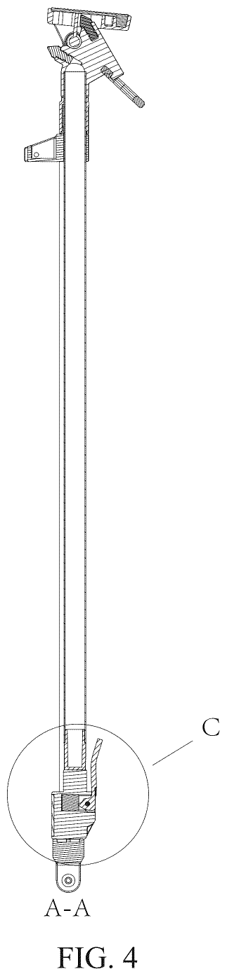

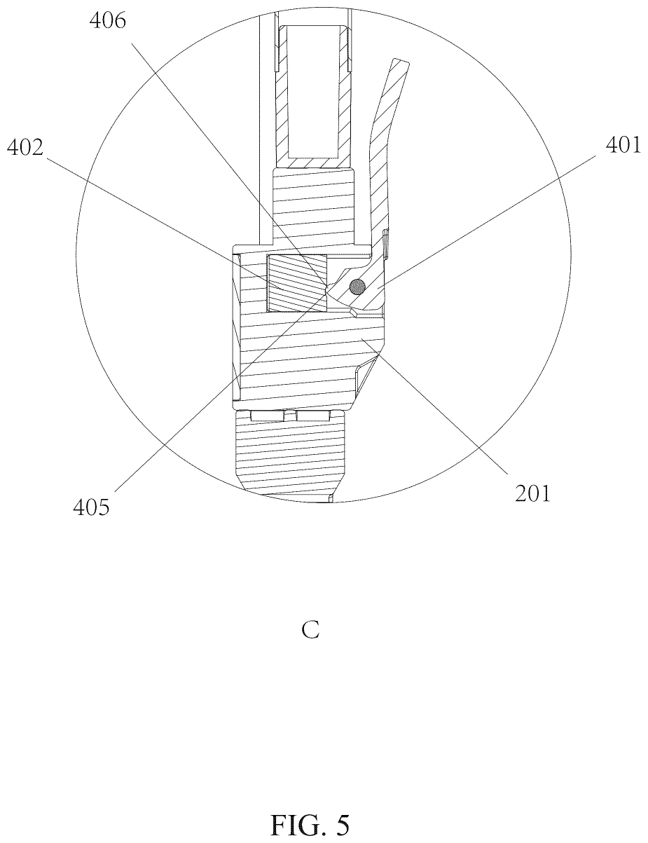

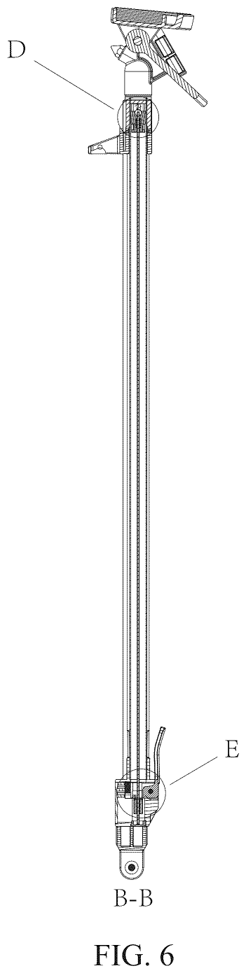

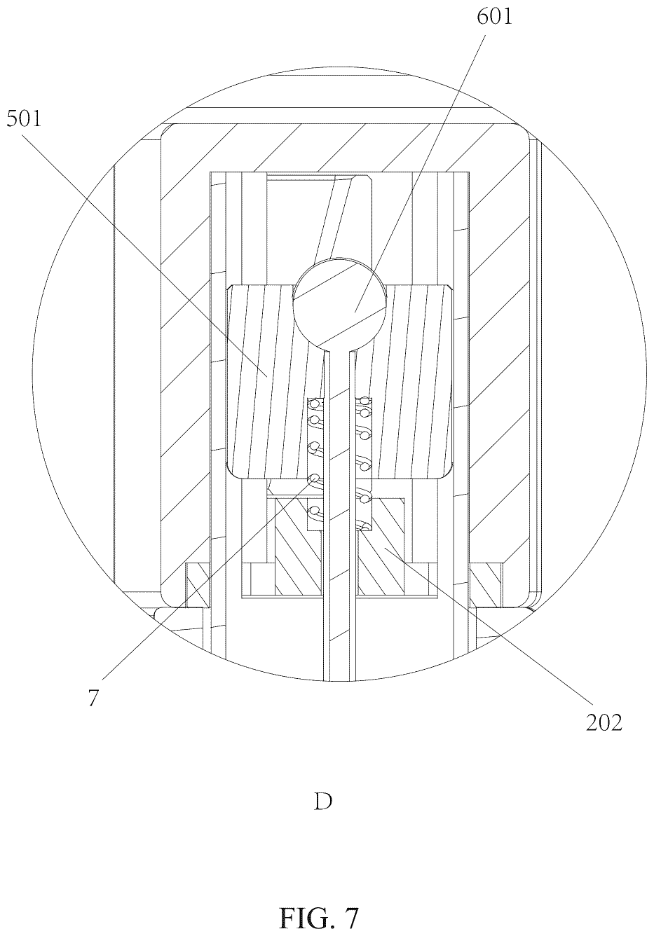

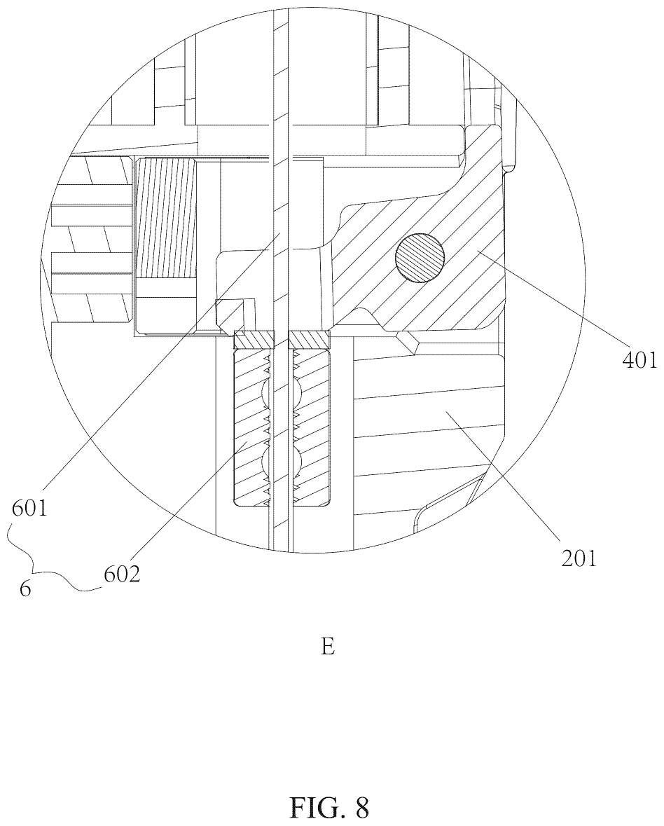

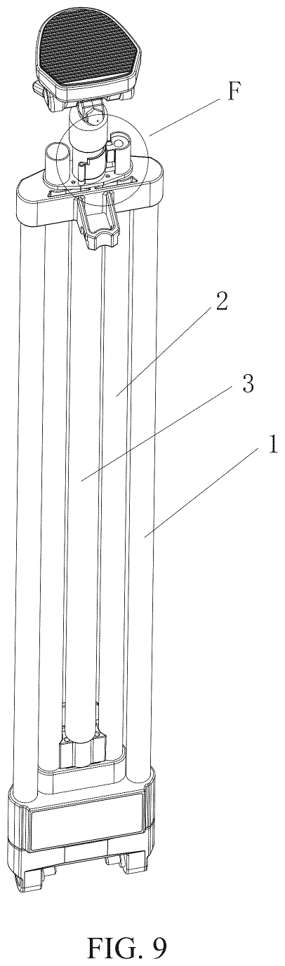

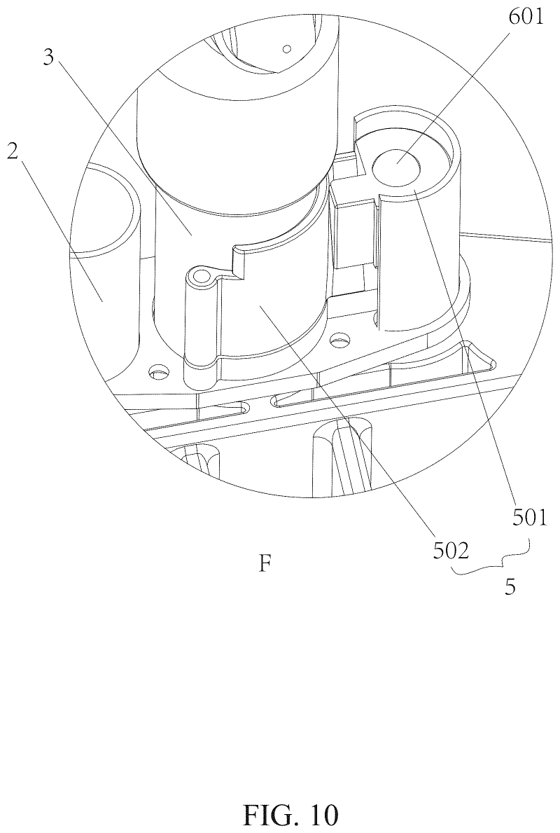

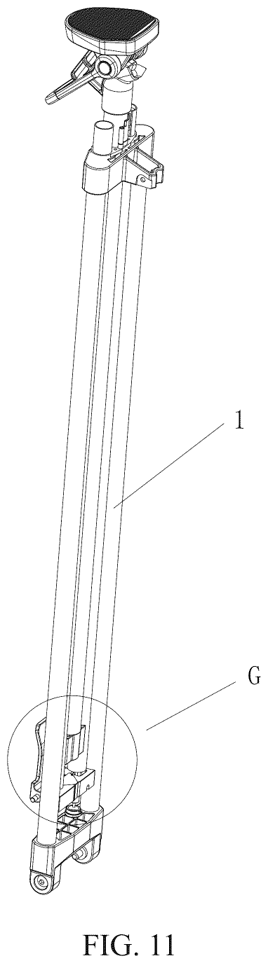

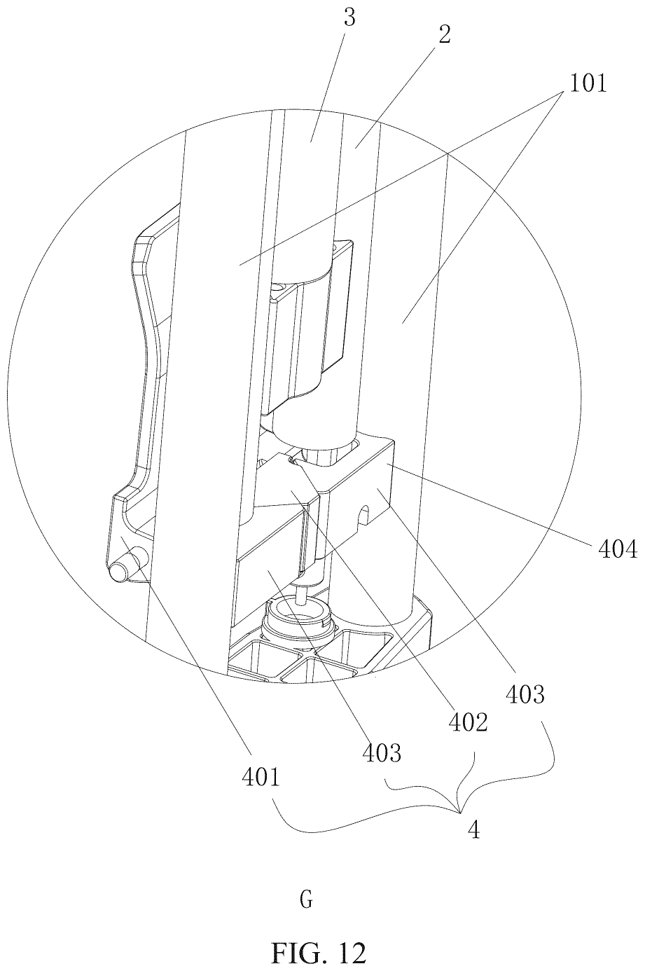

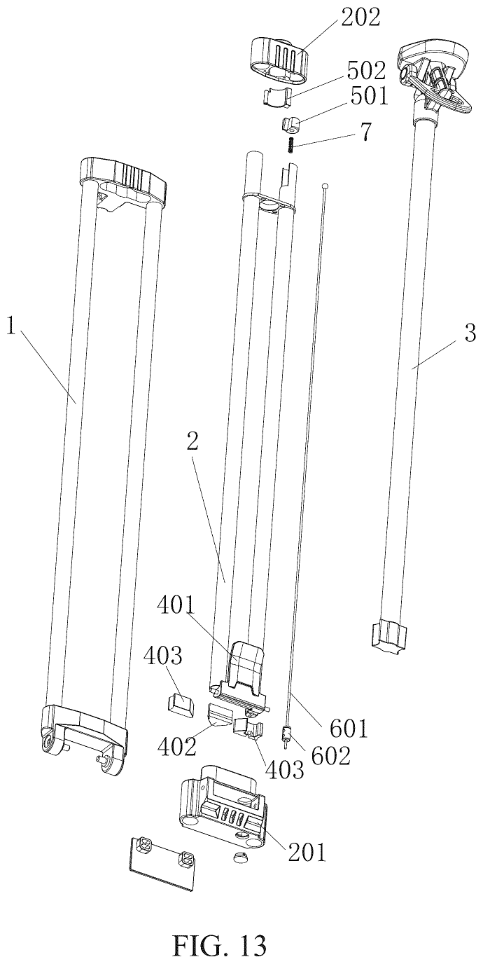

Embodiment: as shown in FIGS. 1-13, a telescopic pipe assembly that can be quickly locked includes a first pipe fitting 1, a second pipe fitting 2, and a third pipe fitting 3 that are sequentially connected and can move relative to each other in an axial direction. The second pipe fitting 2 is provided with a main locking mechanism 4 that limits a relative movement between the second pipe fitting 2 and the first pipe fitting 1, and a secondary locking mechanism 5 that limits a relative movement between the second pipe fitting 2 and the third pipe fitting 3. The main locking mechanism 4 and the secondary locking mechanism 5 are respectively connected to an interlocking mechanism 6. When the main locking mechanism 4 limits the relative movement between the second pipe fitting 2 and the first pipe fitting 1, the interlocking mechanism 6 causes the secondary locking mechanism 5 to limit the relative movement between the second pipe fitting 2 and the third pipe fitting 3. The present application provides a telescopic pipe assembly that can be quickly locked to solve the problem that the locking structure of the existing telescopic pipe assembly can only control the locking and unlocking of adjacent pipe fittings separately, and the locking and unlocking of multiple pipe bodies require repeated operations, which is cumbersome to operate. The solution of the present application is to configure the interlocking mechanism 6 on the main locking mechanism 4 that limits the relative movement between the first pipe fitting 1 and the second pipe fitting 2, and the secondary locking mechanism 5 that limits the relative movement between the second pipe fitting 2 and the third pipe fitting 3. This simplifies the operation and is convenient to use.

In the embodiment of the present application, the second pipe fitting 2 includes a main sliding seat 201 sleeved on the first pipe fitting 1, and the main locking mechanism 4 includes a toggle buckle 401 rotatably connected to the main sliding seat 201, a main pressing block 402 and a main locking block 403 accommodated in the main sliding seat 201. When the toggle buckle 401 rotates relative to the main sliding seat 201, the main pressing block 402 is driven to move forward and backward by the toggle buckle 401. The main locking block 403 is matched with the main pressing block 402, the main locking block moves left and right so as to abut against or release the first pipe fitting 1 under an oblique pushing action of the main pressing block 402 when it moves forward and backward. As the main locking mechanism 4 is configured to be provided with the toggle buckle 401 that is rotatably connected to the main sliding seat 201, the main locking block 403 and the main pressing block 402 cooperate with the toggle buckle 401 to lock or release the first pipe fitting 1, thereby achieving the locking and releasing of the first pipe fitting 1, and the structure is compact and reasonable.

In the embodiment of the present application, the second pipe fitting 2 includes a secondary sliding seat 202 sleeved on the third pipe fitting 3, the secondary locking mechanism 5 includes a secondary pressing block 501 and a secondary locking block 502 accommodated in the secondary sliding seat 202. The secondary locking block 502 is matched with the secondary pressing block 501. When the main locking mechanism 4 locks or releases the first pipe fitting 1, the interlocking mechanism 6 causes the secondary pressing block 501 to move up and down, up and down movements of the secondary pressing block 501 drive the secondary locking block 502 to abut against or release the third pipe fitting 3. Specifically, when the main locking mechanism 4 locks the first pipe fitting 1, the interlocking mechanism 6 causes the secondary pressing block 501 to move upward and drives the secondary locking block 502 to abut against the third pipe fitting 3; when the main locking mechanism 4 releases the first pipe fitting 1, the interlocking mechanism 6 causes the secondary pressing block 501 to move down and drives the secondary locking block 502 to release the third pipe fitting 3. Due to the secondary locking mechanism 5 is configured to be that when the interlocking mechanism 6 locks or releases the first pipe fitting 1, the secondary pressing block 501 moves up and down, and the secondary locking block 502 that locks or releases the third pipe fitting 3 is cooperated with the secondary pressing block 501 by oblique pushing, then the locking and releasing of the third pipe fitting 3 is achieved, and the structure is compact and reasonable.

In the embodiment of the present application, the interlocking mechanism 6 includes a tension rope 601 and a stop column 602. One end of the tension rope 601 is connected to the main sliding seat 201 and the other end of the tension rope 601 is connected to the secondary pressing block 501. The stop column 602 is threaded through the tension rope 601 and cooperates with the toggle buckle 401 to cause the secondary pressing block 501 to move up and down so as to push the secondary locking block 502 to abut against or release the third pipe fitting 3. The toggle buckle 401 releases the stop column 602 and cause the secondary pressing block 501 to move up under the drive of the tension rope 601 when the main locking block 403 is driven to move and abut against the first pipe fitting 1 by the toggle buckle 401. When the secondary pressing block 501 moves up, the secondary locking block 502 is pushed to abut against the third pipe fitting 3. The toggle buckle 401 abuts against the stop column 602 and caused the secondary pressing block 501 to move down when the main locking block 403 is driven to move and release the first pipe fitting 1, and when the secondary pressing block 501 moves down, the secondary locking block 502 is pushed to release the third pipe fitting 3. Specifically, the tension rope 601 is an elastic rope and can cause the secondary pressure block 501 to have a tendency to move upward. Due to the configuration of the interlocking mechanism 6, the tension rope 601 is respectively connected to the main sliding seat 201 and the secondary pressing block 501, and the stop column 602 cooperates with the toggle buckle 401 to cause the secondary pressing block 501 to move up and down, when the main locking mechanism 4 is caused to limit the first pipe fitting 1 to move, the secondary locking mechanism 5 can be caused to limit the movement of the third pipe fitting 3, thereby achieving synchronous locking and unlocking of multiple pipe fittings. And the structure is simple and compact.

In the embodiment of the present application, the secondary sliding seat 202 is provided with an elastic member 7 below the secondary pressing block 501, and an elastic compression of the elastic member 7 causes the secondary pressing block 501 to have an upward movement trend. Due to the presence of the elastic member 7 below the secondary sliding seat 202, which causes the secondary pressing block 501 to have an upward movement trend, the secondary pressing block 501 can quickly move upward when the toggle buckle 401 releases the stop column 602.

In the embodiment of the present application, the secondary locking block 502 is rotatably connected to the secondary sliding seat 202 and at least partially wounds around an outside of the third pipe fitting 3. When the secondary locking block 502 moves upward, the secondary locking block rotates toward the third pipe fitting 3 and abuts against the third pipe fitting 3. Due to the above-mentioned structure of the secondary locking block 502, when the secondary pressing block 501 moves upward, the secondary locking block 502 rotates stably and has good locking ability.

In the embodiment of the present application, the first pipe fitting 1 includes two pipe bodies 101, which are provided on left and right opposite sides and spaced apart. There are two main locking blocks 403, which are respectively provided on left and right sides of the main pressing block 402 and abut against or release the two pipe bodies 101 when the main pressing block 402 moves forward and backward. Due to the fact that the second pipe fitting 2 includes two pipe bodies 101, there are two main locking blocks 403 that respectively abut against or release the two pipe bodies 101 when the main pressing block 402 moves forward and backward. Thus, the structure of the main locking mechanism 4 is stable and the locking effect is excellent.

In the embodiment of the present application, the main locking block 403 includes a surrounding portion 404 provided around an outside of the first pipe fitting 1. Due to the surrounding part 404 of the main locking block 403, which is provided around the first pipe fitting 1, the main locking block 403 has a good locking effect.

In the embodiment of the present application, one side of the main pressing block 402 opposite to the toggle buckle 401 is provided with an avoidance groove 405, and one side of the toggle buckle 401 opposite to the main pressing block 402 is provided with an avoidance strip 406. When the toggle buckle 401 rotates relative to the main sliding seat 201, the avoidance strip 406 is moved into or out of the avoidance groove 405. When the avoidance strip 406 moves away from the avoidance groove 405, the toggle buckle 401 abuts against the main pressing block 402 and causes the main pressing block 402 to move backward. When the main pressing block 402 moves backward, the main locking block 403 is driven to move and abut against the first pipe fitting 1. When the avoidance strip 406 is moved into the avoidance groove 405, the toggle buckle 401 releases the main pressing block 402 and causes the main pressing block 402 to move forward. When the main pressing block 402 moves forward, the main locking block 403 is driven to move forward and release the first pipe fitting 1. The above structure enables the toggle buckle 401 can drive the main pressing block 402 to move forward and backward when it rotates, thereby driving the main locking block 403 to move left and right so as to abut against or release the first pipe fitting 1. The structure is simple and compact.

What is claimed is:

1. A telescopic pipe assembly that can be quickly locked, comprising a first pipe fitting, a second pipe fitting, and a third pipe fitting that are sequentially connected and are capable of moving relative to each other in an axial direction;
wherein the second pipe fitting is provided with a main locking mechanism that limits a relative movement between the second pipe fitting and first pipe fitting, and a secondary locking mechanism that limits a relative movement between the second pipe fitting and the third pipe fitting;
the main locking mechanism and the secondary locking mechanism are respectively connected to an interlocking mechanism, the interlocking mechanism causes the secondary locking mechanism to limit the relative movement between the second pipe fitting and the third pipe fitting when the main locking mechanism limits the relative movement between the second pipe fitting and the first pipe fitting.

2. The telescopic pipe assembly according to claim 1, wherein the second pipe fitting comprises a main sliding seat sleeved on the first pipe fitting; the main locking mechanism comprises a toggle buckle rotatably connected to the main sliding seat, a main pressing block and a main locking block accommodated in the main sliding seat;
the main pressing block is matched with the main locking block; the toggle buckle drives the main pressing block to move forward and backward when rotates relative to the main sliding seat;
forward and backward movements of the main pressing block drive the main locking block to move left and right so as to abut against or release the first pipe fitting.

3. The telescopic pipe assembly according to claim 2, wherein the second pipe fitting comprises a secondary sliding seat sleeved on the third pipe fitting; the secondary locking mechanism comprises a secondary pressing block and a secondary locking block accommodated in the secondary sliding seat; the secondary locking block is matched with the secondary pressing block;
when the main locking mechanism locks or releases the first pipe fitting, the interlocking mechanism causes the secondary pressing block to move up and down; up and down movements of the secondary pressing block drive the secondary locking block to abut against or release the third pipe fitting.

4. The telescopic pipe assembly according to claim 3, wherein the interlocking mechanism comprises a tension rope and a stop column, one end of the tension rope is connected to the main sliding seat and the other end of the tension rope is connected to the secondary pressing block; the stop column passes through the tension rope and cooperates with the toggle buckle to cause the secondary pressing block to move up and down so as to push the secondary locking block to abut against or release the third pipe fitting;
the toggle buckle releases the stop column and causes the secondary pressing block to move upward when the main locking block is driven to move and abut against the first pipe fitting by the toggle buckle; the secondary locking block is pushed to abut against the third pipe fitting when the secondary pressing block moves upward;
the toggle buckle abuts against the stop column and causes the secondary pressing block to move down when the main locking block is driven to move and release the first pipe fitting by the toggle buckle; the secondary locking block is pushed to release the third pipe fitting when the secondary pressing block moves down.

5. The telescopic pipe assembly according to claim 4, wherein the secondary sliding seat is provided with an elastic member below the secondary pressing block, an elastic compression of the elastic member causes the secondary pressing block to move upward.

6. The telescopic pipe assembly according to claim 4, wherein the secondary locking block is rotatably connected to the secondary sliding seat and at least partially wounds around an outside of the third pipe fitting, the secondary locking block rotates toward the third pipe fitting and abuts against the third pipe fitting when the secondary pressing block moves upward.

7. The telescopic pipe assembly according to claim 2, wherein the first pipe fitting comprises two pipe bodies at left and right sides of the first pipe fitting; there are two main locking blocks; the two main locking blocks are respectively provided at left and right sides of the main pressing block and respectively abut against or release the two pipe bodies when the main pressing block moves forward and backward.

8. The telescopic pipe assembly according to claim 2, wherein the main locking block comprises a surrounding part that is provided around an outside the first pipe fitting.

9. The telescopic pipe assembly according to claim 2, wherein one side of the main pressing block opposite to the toggle buckle is provided with an avoidance groove, and one side of the toggle buckle opposite to the main pressing block is provided with an avoidance strip; when the toggle buckle rotates relative to the main sliding seat, the avoidance strip is caused to move into or out of the avoidance groove;
the toggle buckle abuts against the main pressing block so as to cause the main pressing block to move backwards when the avoidance strip is moved away from the avoidance groove; the main pressing block drives the main locking block to move and abut against the first pipe fitting when the main pressing block moves backwards;
the toggle buckle releases the main pressing block so as to cause the main pressing block to move forward when the avoidance strip is moved into the avoidance groove; the main locking block is driven to move and release the first pipe fitting when the main pressing block moves forward.
